(19) United States
(12) Patent Application Publication
(10) Pub. No.: US 2006/0201953 A1
(43) Pub. Date: Sep. 14, 2006

(54) Configuration for kitchen utensils in general, especially pots, pans and other like containers

(75) Inventor: Roberto Modesto Fadanelli, Caxias Do Sul (BR)

Correspondence Address: SUGHRUE MION, PLLC, 2100 PENNSYLVANIA AVENUE, N.W., SUITE 800, WASHINGTON, DC, 20037, US

(73) Assignee: FERNANDEZ SECCO&ASSOCIATES

(21) Appl. No.: 11/074,759

(22) Filed: Mar. 9, 2005

(51) Int. Cl. A47J 39/00

(52) U.S. Cl. 220/592.28

(57) ABSTRACT

A configuration for pots, pans, kitchen utensils in general, and like containers. The container is provided with an inner container and an outer container and a chamber disposed therebetween. A thermal fluid with high thermal conductivity is disposed in at least part of the chamber. A bottom surface of the outer container may include grooves with fins defined on an inner surface of the grooves.

### BACKGROUND OF THE INVENTION

This invention refers to a practical, efficient and novel configuration for pots, pans, kitchen utensils in general, and like containers, the purpose of which is to provide the same with a heat-diffusing fluid, thus producing a uniform temperature along the walls thereof and therefore avoiding a series of inconveniences when cooking. Stainless steel is a material with low thermal conductivity and its use for manufacturing pots is extremely complex. A stainless steel pot with an uncovered bottom, for example, behaves as follows: it presents a temperature curve similar to that which appears on FIG. 1, in whose points A and B there is a heat concentration produced by source C, a gas flame, for example, such concentration being the result of a lack of diffusion caused by the thermal resistance of stainless steel. Such heat concentration results in an uncontrolled rise in the temperature in said points A and B, which may even rise up to 400° C. When in contact with the container's bottom at such high temperatures, food will burn until it is charred and it will stick, recovery thereof being in most cases impossible. Specialized industry has been striving to overcome this problem, and several experiments have been carried out using metals with less thermal resistance, such as aluminum and copper, to try to improve the distribution of heat received from the source, which, although resulting in great improvement, as is shown in the temperature curve which appears on FIG. 2, where it may be noticed that in points A and B temperature is lower while increasing a little more in the other points, due to use of a diffusion point (D) and therefore improving heat distribution—there still persist some high temperature areas. Such high temperature areas force users to pay constant attention while cooking, which increases the users' weariness.

### SUMMARY OF THE INVENTION

It is therefore an object of the present invention to provide a container with a thermal fluid to improve the heat distribution of the container.

According to one exemplary embodiment of the container there is provided an inner container; an outer container at least partially surrounding said inner container; and a chamber between said inner container and said outer container; wherein said chamber is at least partially filled with a thermal fluid with high thermal conductivity.

According to another exemplary embodiment a container is provided with an inner wall; an outer wall with at least portions spaced apart from said inner wall; and a chamber defined between said inner wall and said outer wall; wherein said chamber is at least partially filled with a thermal fluid with high thermal conductivity.

According to another exemplary embodiment a container is provided with an inner container; an outer container at least partially surrounding said inner container and including a bottom surface with at least one groove which defines at least one fin; a chamber between said inner container and said outer container; and an autogenous seal for sealing said chamber; wherein said chamber is at least partially filled with a thermal fluid with high conductivity.

### BRIEF DESCRIPTION OF THE DRAWINGS

The above and other objects, features and advantages of the invention will become more apparent by describing in detail exemplary embodiments thereof with reference to the attached drawings in which:

FIG. 1 is a vertical sectional view a stainless steel pot with an uncovered bottom.

FIG. 2 is a vertical sectional view a container with a bottom with less thermal resistance than stainless steel.

FIG. 3 is a vertical sectional view of a container according to an exemplary embodiment of the present invention.

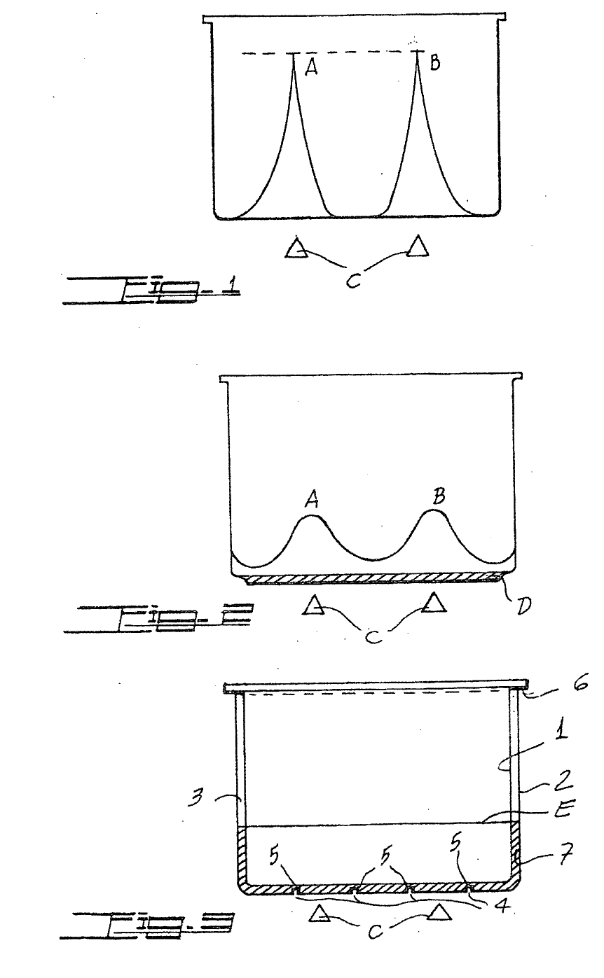

### DETAILED DESCRIPTION OF THE INVENTION

Exemplary embodiments of the invention will now be described below by reference to the attached Figures. The described exemplary embodiments are intended to assist the understanding of the invention, and are not intended to limit the scope of the invention in any way.

In order to solve all the above inconveniences, the applicant has conceived a system for manufacturing cooking utensils which produces containers with a total diffusion of the heat they receive, therefore considerably improving food cooking conditions.

As it may be observed in FIG. 3, which shows a vertical section of an exemplary embodiment of a container manufactured following the novel configuration, one novelty of such container is that it has been provided with a set of double walls, thus resulting in an inner container (1) and another outer container (2) with an air chamber (3) between them, not only on the sides thereof but on its bottom as well; the bottom of the external container is provided with grooves (4) which form fins on the inner face thereof, which are set in the proper direction, the whole set being provided with a permanent autogenous seal (6) along all the extension thereof. The air chamber (3) is partly occupied by the appropriate volume of a high-conductivity thermal fluid (7), which assures that the container walls involved with it shall have a uniform temperature, the distribution curve becoming therefore flat, as is shown on letter “E” of FIG. 3. An exemplary embodiment of a container of the present invention results in the following advantages:

a) food is now cooked as in “bain-marie”, but with a temperature which may be regulated;

b) the need for food to be stirred or mixed during cooking is dramatically reduced;

c) the container now behaves as if it were lined in a nonstick material, but avoiding the inconveniences of such materials;

d) the thermal fluid transmits heat in a uniform way, which allows for a significant economy;

e) this container has an excellent performance with fried foods, since it prevents oxidization of edible cooking oil;

f) it has a higher thermal inertia, which causes foods to be heated during a longer time while they are inside the container,

The fins of the exemplary embodiment (5) which increase the heat exchange surface, are also less energy-consuming, and even ensure that the container's bottom will keep its shape.

The exemplary embodiment of this novel container is extremely safe, even when heated over a flame without any contents, since its shape is not altered and the air chamber (3) will absorb any expansions in the fluid (7), thus keeping the container intact for years. This container may be taken straight from the freezer to the stove without any trouble, and will accept all types of heating, such as gas, electricity, wood, etc.

This invention has been described herein in considerable detail in order to comply with the Patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures can be accomplished without departing from the scope of the invention itself.

What is claimed is:

1. A container comprising:
an inner container;
an outer container at least partially surrounding said inner container; and
a chamber between said inner container and said outer container;
wherein said chamber is at least partially filled with a thermal fluid with high thermal conductivity.

2. The container of claim 1, wherein said outer wall includes a bottom surface which includes at least one groove with a fin defined on an inner surface of said groove.

3. The container of claim 1, wherein said chamber is also at least partially filled with air.

4. The container of claim 1, wherein said container further comprises a seal for sealing said chamber.

5. The container of claim 4, wherein said seal further connects said inner container and said outer container together.

6. The container of claim 4, wherein said seal is an autogenous seal.

7. A container comprising:
an inner wall;
an outer wall with at least portions spaced apart from said inner wall; and
a chamber defined between said inner wall and said outer wall;
wherein said chamber is at least partially filled with a thermal fluid with high thermal conductivity.

8. The container of claim 7, wherein said outer wall includes a bottom surface which includes at least one groove with a fin defined on an inner surface of said groove.

9. The container of claim 1, wherein said chamber is also at least partially filled with air.

10. The container of claim 1, wherein said container further comprises a seal for sealing said chamber.

11. The container of claim 10, wherein said seal further connects said inner container and outer container together.

12. The container of claim 10, wherein said seal is an autogenous seal.

13. A container comprising:
an inner container;
an outer container at least partially surrounding said inner container and including a bottom surface with at least one groove with a fin defined on an inner surface of said groove;
a chamber between said inner container and said outer container; and
an autogenous seal for sealing said chamber;
wherein said chamber is at least partially filled with a thermal fluid with high conductivity.

14. The container of claim 13, wherein said chamber is also at least partially filled with air.
